(19) United States
(12) Patent Application Publication
(10) Pub. No.: US 2009/0186133 A1
(43) Pub. Date: Jul. 23, 2009

(54) MICROWAVEABLE CUP ARRANGEMENT AND METHODS

(76) Inventors: Chris Bjork, Lake Benton, MN (US); Robert B. Shomo, JR., Balaton, MN (US)

Correspondence Address: MERCHANT & GOULD PC, P.O. BOX 2903, MINNEAPOLIS, MN, 55402-0903, US

(21) Appl. No.: 12/017,457

(22) Filed: Jan. 22, 2008

(51) Int. Cl. A23L 3/00

(52) U.S. Cl. 426/234; 220/254.1

(57) ABSTRACT

A microwaveable cup arrangement includes a cup, a microwaveable shield layer along at least a first portion of the cup, a microwaveable susceptor layer along at least a second portion of the cup, and a removable lid defining a storage area and having an aperture arrangement in communication with the interior volume of the cup. The cup arrangement can be used to hold an edible food arrangement including a food arrangement in which a portion is to remain cold, a portion is be heated, and a portion is be melted and distributed on the rest. One example includes an ice cream sundae.

### CROSS-REFERENCE TO RELATED APPLICATIONS

### TECHNICAL FIELD

This disclosure relates to microwaveable packaging. In particular, this disclosure relates to a microwaveable cup arrangement having a lid with apertures for melting and for distribution of a topping on the product within the cup.

### BACKGROUND OF THE DISCLOSURE

It is sometimes desirable to prepare food, in which one portion of the food is cold, while another portion of the food is hot. Some foods include a cold item with a hot sauce or topping drizzled or poured over the cold item. These foods can be separately prepared, but that is often inconvenient.

Frozen microwaveable foods offer the convenience of having the food prepared in advance, while preparing it for eating only takes a few minutes or less by exposing the food to microwave energy.

There is a problem with foods in which it is desired to have part of the food cold and the sauce or topping hot in exposing such foods to microwave energy. In such instances, it is difficult to sufficiently heat the sauce while maintaining the cold product cold. Improvements are desirable.

### SUMMARY OF THE DISCLOSURE

A microwaveable cup arrangement comprises a cup including a cup surrounding wall, a bottom, and an open top. The surrounding wall and the bottom together define an entire volume. A microwaveable shield layer is along at least a first portion of the cup. A microwaveable susceptor layer is along at least a second portion of the cup. A removable lid is removably secured to the cup at the open top. The removable lid defines a storage area, the storage area having an aperture arrangement in communication with the interior volume of the cup.

In another aspect, a microwaveable cup arrangement is provided including a cup having a cup surrounding wall, a bottom, and an open top; the cup surrounding wall and the bottom together define an interior volume. A removable lid is removably secured to the cup at the open top. The removable lid has a closed top wall and a perimeter side wall surrounding the top wall. The perimeter side wall defines a lid opening opposite of the cup wall. A susceptor plate is oriented in the lid opening and is axially spaced from the closed top wall. The susceptor plate defines an aperture arrangement in communication with the interior volume of the cup. The susceptor plate, perimeter side wall, and closed top wall together define a lid storage volume.

In another aspect, a microwaveable food and packaging arrangement comprises a cup including a cup surrounding wall, a bottom, and an open top; the surrounding wall and the bottom together defining an interior volume; a microwaveable shield layer along at least a first portion of the cup; a first food item in the first interior volume and radially adjacent to the microwaveable shield layer; a microwaveable susceptor layer along at least a second portion of the cup; a second food item in the cup interior volume and radially adjacent to the microwaveable susceptor layer; and a removable lid removably secured to the cup at the open top; the removable lid defining a storage area; the storage area having an aperture arrangement in communication with the interior volume of the cup. Preferably, there is a third food item in the storage area of the lid.

In one embodiment, there is a removable cover, removably covering or exposing the storage area of the lid.

In one arrangement, the first food item comprises ice cream, ice milk, custard, pudding, sorbet, malt, yogurt, fruit, fillings, cold confections, or blends thereof; the second food item comprises a brownie, cake, cookie, biscuit, bread, pie, or blends thereof; and the third food item comprises toppings, including chocolate, caramel, butterscotch, fruit, syrup, fudge, sauce, or blends thereof.

In another aspect, a method for making an edible arrangement includes applying microwaveable energy to a cup arrangement; the cup arrangement holding at least first and second food items; the first and second food items being held in axial relation to each other within an interior volume of a cup; shielding at least the first food item from the microwave energy; heating at least the second food item with the microwave energy and a microwaveable susceptor; heating a third food item with the microwave energy held within a storage area of a removable lid removably attached to the cup; and allowing the third food item to flow into the interior food volume of the cup through an aperture arrangement in the storage area of the lid.

### BRIEF DESCRIPTION OF THE DRAWINGS

FIG. 1 is a perspective view, with portions broken away to show internal components, of one embodiment of a cup arrangement constructed according to principles of this disclosure;

FIG. 2 is a perspective view of the cup arrangement of FIG. 1, and including a top cover, which was not shown in FIG. 1;

FIG. 3 is a right side elevational view of the cup arrangement of FIG. 2;

FIG. 4 is a top plan view of the cup arrangement depicted in FIG. 3; the hidden lines depicting structure beneath the removable lid;

FIG. 5 is a schematic, cross-sectional view of the cup arrangement depicted in FIG. 3, the cross-section being taken along the line V-V;

FIG. 6 is an exploded, perspective view of the cup arrangement of FIGS. 2-5, depicting the structural components as well as the internal food components;

FIG. 7 is an exploded, perspective view of another embodiment of a cup arrangement, constructed in accordance with principles of this disclosure;

FIG. 8 is a perspective view of an assembled removable lid and susceptor depicted in FIG. 7; and

FIG. 9 is a perspective view, partially cut away, of the assembled lid and susceptor depicted in FIG. 8.

### DETAILED DESCRIPTION

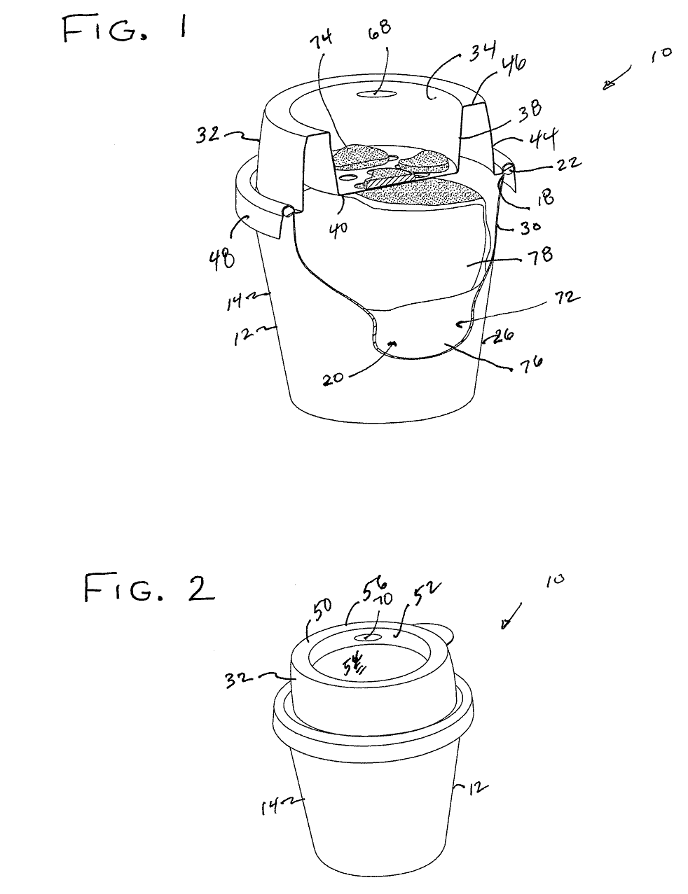

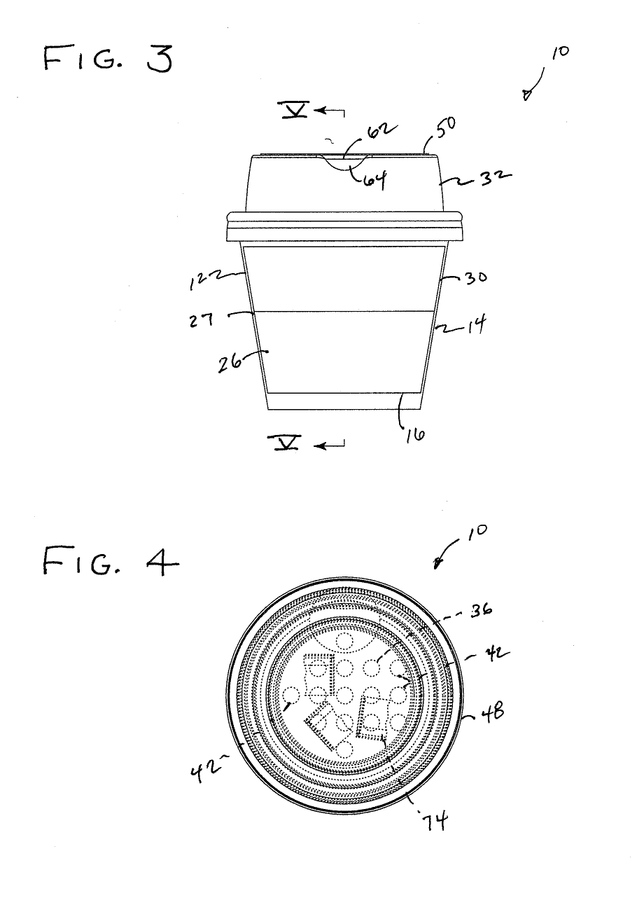

FIGS. 1-6 depict one embodiment of a microwaveable cup arrangement 10. A number of different embodiments are contemplated, and the embodiment depicted in FIGS. 1-6 at reference numeral 10 is one example only. The microwaveable cup arrangement 10 is useful in addressing some of the shortcomings in the prior art, including providing a convenient microwaveable frozen product that may be prepared quickly without the preparation hassle, time commitment, and creation of dirty dishes. As explained below, one example use for the cup arrangement includes an ice cream sundae, including ice cream and the ice cream topping that will melt and drizzle on top of the ice cream. In addition, a brownie or bakery-type product may also be included in the arrangement. Many variations are contemplated, and an ice cream sundae is just one example provided for purposes of illustration.

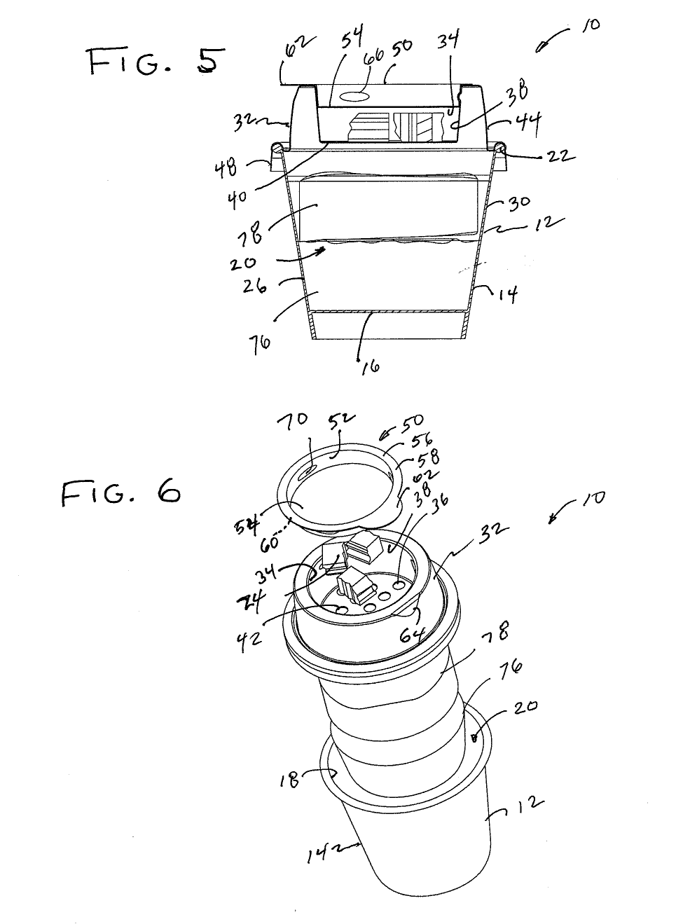

In the embodiment shown in FIGS. 1-6, the cup arrangement 10 includes a cup 12 having a cup surrounding wall 14. The cup surrounding wall 14, in the embodiment shown, generally has a circular cross-section, and the wall 14 itself can be angled such that the overall cup 12 has a slight conical shape. The cup 12 further includes a bottom 16 (FIGS. 3 and 5) and an open top 18 (FIGS. 1 and 6). Together, the surrounding wall and the bottom 16 define an interior volume 20 (FIGS. 1, 5, and 6).

In the embodiment shown, the open top 18 of the cup 12 is defined by a circular rim 22 (FIGS. 1 and 5). The rim 22, in the embodiment shown is shaped to receive a corresponding portion of a removable lid 32, to be described further below.

In accordance with principles of this disclosure, the cup includes a microwaveable shield layer along at least a first portion of the cup. In the particular embodiment of the cup 12 depicted, a microwaveable shield layer 26 (FIGS. 1, 3, and 5) is located along the cup surrounding wall 14 to completely radially surround that portion of the interior volume 20. The shield layer 26 can be located in a variety of places along the cup surrounding wall 14. For example, in one embodiment, the shield layer 26 can extend completely the length of the cup 12 from the open top 18 to the bottom 16. In other embodiments, the shield layer 26 extends only a partial length of the cup surrounding wall 14. In preferred embodiments, the shield layer 26 extends along the cup surrounding wall 14 between 20-80% of the overall length of the surrounding wall 14.

In the embodiment shown in FIGS. 1, 3, and 5, the shield layer 26 extends along the cup surrounding wall 14 from adjacent the cup bottom 16 to some portion spaced from the open top 18. As shown in FIGS. 3 and 5, the shield layer 26 extends from immediately adjacent the bottom 16 to a location about 40-70% of the overall length of the cup surrounding wall 14 and spaced from the open top 18. In other embodiments, the shield layer 26 extends along the cup surrounding wall 14 spaced from the bottom 16.

The shield layer 26 helps to slow down or prevent microwave energy from increasing the temperature of the food item 76 that is located within the interior of the shied layer 26. In one example embodiment, the food item 76 comprises an item that it is desired to keep frozen or cold, for example, a temperature of less than 60° F. Examples of the first food item 76 include ice cream, ice milk, custard, pudding, sorbet, malt, yogurt, fruit, fillings, cold confections, or blends thereof.

Usable materials for the microwave shield 26 include any materials usable as microwave shielding including, for example, aluminum particles, printed inks, or other metallic compounds.

In some arrangements, there is further a microwaveable susceptor layer 30 along at least a second portion of a cup 12. The susceptor layer 30 may be oriented along any portion of the cup surrounding wall 14, including the entire length of the cup surrounding wall 14, along a portion adjacent to the rim 22, along a portion adjacent to the bottom 16 or along a portion spaced from both the bottom 16 and the open top 18. In the embodiment shown, the susceptor layer 30 is spaced from the cup bottom 16.

In the specific embodiment shown in FIGS. 1, 3, and 5, the susceptor layer 30 extends along the cup surrounding wall 14 from a point immediately adjacent to the shield layer 26 up to the open top 18. In other embodiments, the susceptor layer 30 can be spaced a distance from the shield layer 26 and/or be spaced from the open top 18. The susceptor layer 30 typically will extend along the cup surrounding wall 14 a distance between 20-80% of the overall length of the surrounding wall 14.

In preferred embodiments, the microwaveable shield layer 26 extends along the cup surrounding wall 14 from adjacent the cup bottom to 20-80% of the overall length of the cup surrounding wall 14 and has a shield layer end 27 (FIG. 3) remote from the cup bottom 16. The microwaveable susceptor layer 30 extends along the cup surrounding wall 14 from adjacent the shield layer end 27 in a direction toward the open top 18 and extends over a length of 20-80% of the overall length of the cup surrounding wall 14. Usable materials for the susceptor wall 30 include any materials usable as microwave susceptors including, for example, aluminum particles, printed inks, or any other metallic compounds.

In accordance with principles of this disclosure a removable lid is provided removably secured to the cup at the open top. As embodied herein, a removable lid 32 is secured, typically by snap or friction-fit to the cup 12 at the open top 18. The lid 32 defines a storage area 34. The storage area 34 can define an aperture arrangement 36 (FIGS. 1, 4, and 6, in communication with the interior volume 20 of the cup 12). While a variety of embodiments are contemplated, in the particular embodiment shown, the lid 32 includes a storage area wall 38 and a storage area floor 40 connected to the storage area wall 38. Together, the storage area wall 38 and the storage area floor 40 define the storage area 34. As can be seen in FIGS. 5 and 6, the storage area wall 38 is a continuous, surrounding wall that circumscribes the storage area 34. The floor 40 is depicted as generally horizontal when the cup 12 is in an upright standing position. The storage area wall 38 is generally perpendicular to the floor 40, with some slight angle due to molding, for example. In the embodiment shown, the floor 40 defines the aperture arrangement 36.

In preferred embodiments, the storage area 34 has a size sufficient to hold an edible item that can be melted in order to fall by way of gravity through the aperture arrangement 36. Usable sizes for the storage area 34 include at least 10 cubic inches, no greater than 50 cubic inches and typically 20-30 cubic inches.

In the embodiment shown, the aperture arrangement 36 comprises a plurality of openings in the form of apertures 42, which can be slots, slits, holes, perforations, etc. In one example embodiment, the ratio on the floor 40 of open area to closed area is about 5:100.

In the embodiment shown, the lid 32 further includes an outer wall 44 radially spaced from and circumscribing the storage area wall 38. Adjoining the outer wall 44 and the storage area wall 38, in the embodiment shown is a joining wall 46. In the embodiment shown, the joining wall 46 is generally parallel to the floor 40 and roughly perpendicular to the storage area wall 38 and outer wall 44, with a slight variation from perpendicular due to the sloping of the walls 38 and 44, in this example embodiment. The joining wall 46 is generally flat in this embodiment and forms a resting surface for other structure, such as an optional removable top cover, to be described further below.

The lid 32 further includes an outer rim 48 radially and axially spaced from and circumscribing the outer wall 44. The outer rim 48 is constructed and arranged for engaging the cup 12 at the rim 22 at the open top 18. The engagement can be, for example, snap-fit or friction-fit.

In some arrangements, the cup arrangement 10 will further include an optional removable top cover 50 removably oriented to selectively cover or expose the lid storage area 34. In the embodiment shown, the cover 50 includes a cover surrounding wall 52 and a cover plate 54. The cover plate 54 is circumscribed, or surrounded by the cover surrounding wall 52. In the embodiment shown, in use, the cover plate 54 is generally parallel to the storage area floor 40. Adjacent to the cover surrounding wall 52 is a cover flange 56. The cover flange 56 has an upper side 58 and an opposite, lower side 60. The lower side 60 in use, engages and is against the joining wall 46 of the lid 32, when the cover 50 is operably arranged in place to cover the storage area 34.

In embodiments that use the removable top cover 50, there can be structure to aid in the removal of the cover 50 from the lid 24. In the embodiment shown, the structure includes a finger tab 62. In the embodiment shown, the finger tab 62 is an extension of the cover flange 56 and extends beyond an outer edge of the joining wall 46 of the lid 32. In some embodiments, the lid 32 will also include structure to aid in the removal of the lid 32 from the cup 12. In the embodiment shown, the lid finger tab 64, in use, is aligned with the cover finger tab 62. The lid finger tab 64 may be angled in a direction toward the cup 12. The lid finger tab 64, of course, helps facilitate the removal of the lid 32 from the cup 12.

In the embodiment shown, there is further a detent/recess arrangement between the cover 50 and the lid 32 to help secure the cover 50 in an operable covering position relative to the storage area 34. In the embodiment shown, a detent/recess arrangement 66 is between the cover surrounding wall 52 and the storage area surrounding wall 38. In the embodiment shown, the storage area surrounding wall 38 includes a projection or detent 68 (FIG. 1), and the cover surrounding wall 52 includes a recess 70 (FIG. 6). This arrangement 66 allows the detent 68 to be snap-fit or friction-fit into the recess 70 in order to help secure the cover 50 onto the lid 32. Of course, the detent 68 and recess 70 can be reversed such that the detent 68 is on the cover 50 while the recess 70 is on the lid 32. In addition, other securing arrangements are contemplated and possible.

In the embodiment shown, the finger tab 62 is located between 150°-210°relative to the detent/recess arrangement 66. In the illustrated embodiment, the finger tab 62 is located about 180° relative to the detent/recess arrangement 66. Similarly, the lid finger tab 64 is located 150°-210° relative to the detent/recess arrangement 66, and is illustrated as being about 180° relative to the detent/recess arrangement 66. This relative arrangement of the finger tabs 62, 64 relative to the detent/recess arrangement 66 allows for convenient and easy selective removal of the cover 50 from the lid 32.

As mentioned above, the cup arrangement 10 is particularly useful for holding food, and can be particularly useful for holding food to be microwaved. In general, there can be a food item 72 in the interior volume 20 of the cup 12, and a food item 74 within the storage area 34 of the lid 32. In preferred arrangements, the food item 72 within the interior volume 20 of the cup 12 includes at least first and second food items 76, 78. The first food item 76 is oriented in the interior volume 20 of the cup 12 and is radially-adjacent to the microwaveable shield layer 26. The second food item 78 is located within the interior volume 20 of the cup 12 and is radially-adjacent to the microwaveable susceptor layer 30, in this example embodiment. This arrangement allows the first food item 76 to remain shielded from the microwave energy, while the second food item 78 is allowed to be heated by microwave energy.

A variety of food arrangements are usable. Examples of usable first food items 76 include ice cream, ice milk, custard, pudding, sorbet, malt, yogurt, fruit, fillings, cold confections, or blends thereof. Usable second food items 78 may include a brownie, cake, cookie, biscuit, bread, pie, crust, or blends thereof. Usable ingredients for the food items 74 within the storage area 34 include toppings, such as chocolate, caramel, butterscotch, fruit, syrup, fudge, cheese, frosting, white chocolate, or blends thereof.

One example food arrangement includes an ice cream sundae with ice cream, ice milk, frozen yogurt, or sorbet located in the area adjacent to the shield layer 26, a brownie, cake, or cookie, located in the area adjacent the susceptor layer 30, and chocolate chunks or fudge chunks located in the storage area 34. In this arrangement, the microwave energy will melt the food item 74, such as the chocolate or fudge chunks in the storage area 34. The melted food item 74 will fall by gravity through the aperture arrangement 36 and onto the second food item 78, such as the brownie, cake, or cookie. The food item 76, such as the ice cream, ice milk, frozen yogurt, or sorbet will stay cold because it is blocked from receiving microwave energy from the shield layer 26. Thus, for example, the cup arrangement 10 can be used for holding a microwaveable hot fudge sundae, in which the ice cream stays cold, the chocolate or fudge is heated and melted, and the brownie is warmed up.

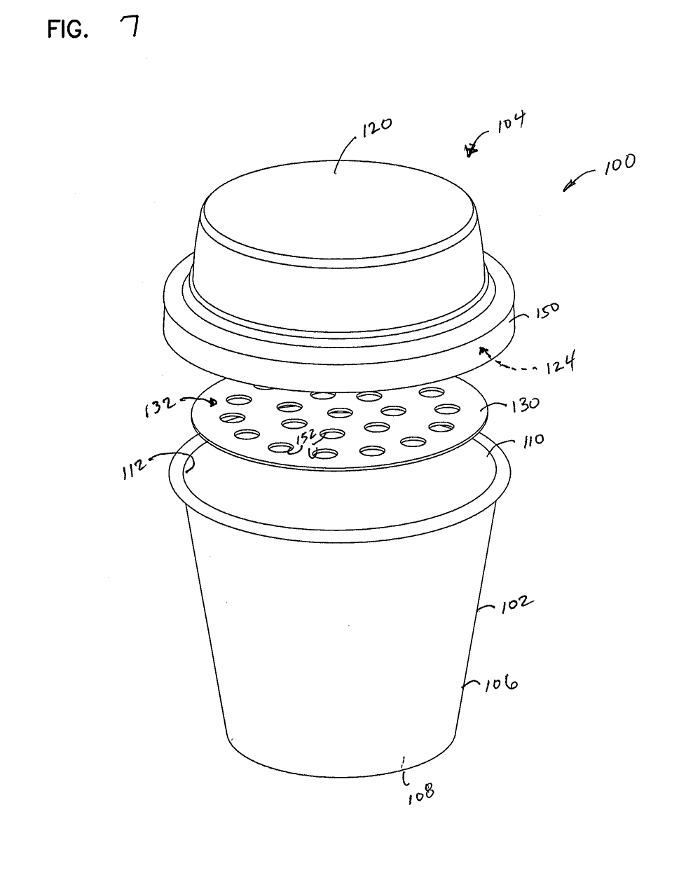

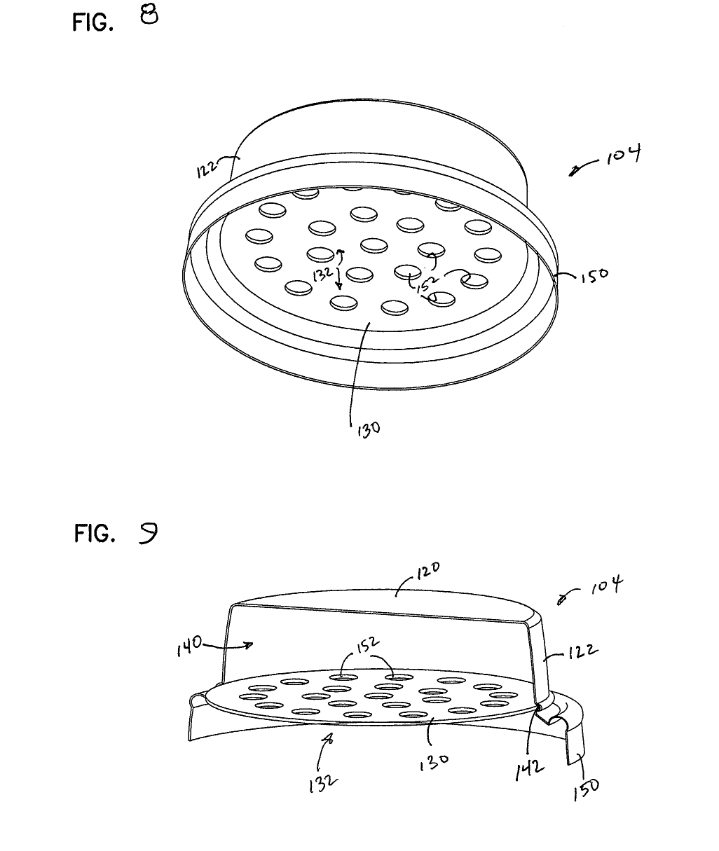

FIGS. 7-9 illustrate a second embodiment of a cup arrangement 100. The cup arrangement 100 includes a cup 102 and a removable lid 104. In this embodiment, the cup 102 can be structured the same as cup 12, described above. As such, the cup 102 includes a cup surrounding wall 106, a bottom 108, and an open top 110. The surrounding wall 106 and the bottom 108 define an interior volume 112. The cup 102 can be a plain cup, or it can also include a shield layer and/or a susceptor layer as illustrated for the cup 12 described in connection with FIGS. 1-6. It should be understood that the cup 12 illustrated in FIG. 1 having the shield layer 26 and susceptor layer 30 can be substituted for the illustration of the plain cup 102 of FIG. 7.

In the embodiment of FIGS. 7-9, the removable lid 104 varies from the lid 32 described in connection with the embodiment of FIGS. 1-6. In this embodiment, the lid 104 is also removably secured to the cup 102 at the open top 110, but in this embodiment, the removable lid 104 has a closed top wall 120. The lid 104 further includes a perimeter side wall 122 surrounding the top wall 120. In the embodiment shown, the perimeter side wall 122 is generally angled relative to the top wall 120. In the embodiment shown, deviating somewhat from an orthogonal relationship. The perimeter sidewall 122 defines a lid opening 124, shown in phantom in FIG. 7. In the lid opening 124 is the open area or mouth that is opposite of the top wall 120.

The removable lid 104, in this embodiment, further includes a susceptor plate 130 oriented in the lid opening 124 and axially spaced from the closed top wall 120. In the embodiment shown, the susceptor plate 130 defines an aperture arrangement 132 in communication with the interior volume 112 of the cup 102. Together, the susceptor plate 130, the perimeter side wall 122, and the closed top wall 120 define a lid storage volume 140 (FIG. 9).

In the embodiment shown, the perimeter sidewall 122 defines a groove 142 (FIG. 9). The susceptor plate 130, in this embodiment, is held by the lid 104 by being oriented within the groove 142. The susceptor plate 130 can be held by the groove 142 by a friction engagement or snap fit.

In the embodiment shown, the perimeter side wall 122 further includes an end rim arrangement 150. The end rim arrangement 150 is constructed and arranged for frictional engagement with a cup surrounding wall 106 at the open top 110. In the embodiment shown, the susceptor plate 130 is axially-spaced between the end rim arrangement 150 and the closed top wall 120.

In the embodiment shown, the aperture arrangement 132 in the susceptor plate 130 comprises a plurality of through holes 152 extending through the susceptor plate 130. The through holes 152 can be any type of opening, including a screen, slots, a grid, various geometric shapes and in the embodiment shown, are circular holes. In one useful arrangement, the susceptor plate 130 is about 1-10% open area, for example, about 5% open area. In one arrangement, the susceptor plate 130 is made from a paperboard material and includes microwaveable susceptor material on a substantial portion of the non-apertured area. The microwaveable susceptor material will include any materials usable as susceptors, including, for example, aluminum particles, printed inks, or any other metallic compounds.

In use, the cup arrangement 100 can be pre-stored or pre-loaded with a food within the lid storage volume 140 and sold to the consumer with the storage volume 140 pre-loaded with the food. The food in the storage volume 140 can be any type of food where it is desirable to melt with microwave energy to allow for it to fall by gravity or drizzle through the aperture arrangement 132 and into the cup 102 below. As described above, one arrangement can include within the lid storage volume 140 toppings, such as chocolate, caramel, butterscotch, fruit, syrup, fudge, cheese, frosting, or blends thereof. Within the interior volume 112 of the cup 102, it can include at least a first food item, or as described above, first and second food items. The first food item can comprise ice cream, ice milk, custard, pudding, sorbet, malt, yogurt, fruit, fillings, cold confections, or blends thereof. The second food item can include a brownie, cake, cookie, biscuit, bread, pie, or blends thereof. In this way, the cup arrangement 100 may be provided to the consumer pre-loaded with the various foods, and the consumer merely needs to place it in the microwave. For example, the cup arrangement 100 can be pre-loaded with the various foods to create an ice cream sundae having the appropriate ingredients for an ice cream sundae.

The cup arrangement 10 and 100 can be used in a method for making an edible arrangement. As referenced below, the method will make use to cup arrangement 10, but it should be understood that these method principles equally apply to the arrangement of cup arrangement 100. The method includes applying microwave energy to the cup arrangement 10, in which the cup arrangement 10 holds at least first and second food items 76, 78. The first and second food items 76, 78 are held in axial relation to each other within the interior volume 20 of the cup 12. The method includes shielding at least the first food item 76 from the microwave energy, and heating at least the second food item 78 with the microwave energy and a microwaveable susceptor. The method also includes heating a third food item 74 with the microwave energy held within the storage area 34 of the removable lid 32 removably attached to the cup 12. The method further includes allowing the third food item 74 to flow into the interior volume 20 of the cup 12 through the aperture arrangement 36 in the storage area 34 of the lid 32.

In one implementation, for the cup arrangement 10, the method further includes removing the cover 50 from the lid 32 to expose the storage area 34. This can allow for the access to the chocolate or topping within the storage area 34. In addition, before the arrangement 10 is microwaved, the user may put a food item to be melted within the storage area 34, such as chocolate chips, caramels, cheese, etc.

The above specification, examples and data provide a complete description of the example principles of inventive concepts. Many embodiments can be made, applying principles disclosed herein.

We claim:

1. A microwaveable cup arrangement comprising:
(a) a cup including a cup surrounding wall, a bottom, and an open top; the surrounding wall and the bottom together defining an interior volume;
(b) a microwaveable shield layer along at least a first portion of the cup;
(c) a microwaveable susceptor layer along at least a second portion of the cup; and
(d) a removable lid removably secured to the cup at the open top;
(i) the removable lid defining a storage area; the storage area having an aperture arrangement in communication with the interior volume of the cup.

2. A cup arrangement according to claim 1 wherein the lid includes a storage area wall and a floor connected to the storage area wall;
(a) the storage area wall and the floor together defining the storage area;
(b) the floor defining the aperture arrangement.

3. A cup arrangement according to claim 2 wherein the aperture arrangement includes a plurality of apertures.

4. A cup arrangement according to claim 2 wherein the lid further includes:
(a) an outer wall radially spaced from and circumscribing the storage area wall; and
(b) an outer rim radially and axially spaced from and circumscribing the outer wall; the outer rim being constructed and arranged for engaging the cup at the open top.

5. A cup arrangement according to claim 4 further including a removable top cover removably oriented to selectively cover or expose the lid storage area.

6. A cup arrangement according to claim 5 wherein the removable top cover includes a finger tab projecting from a remaining portion of the top cover.

7. A cup arrangement according to claim 6 wherein the removable top cover and the storage area wall have a detent/recess arrangement to secure the removable top cover in operable covering position relative to the storage area.

8. A cup arrangement according to claim 7 wherein the finger tab is located 150°-210° relative to the detent/recess arrangement.

9. A cup arrangement according to claim 1 wherein:
(a) the microwaveable susceptor layer extends along the cup surrounding wall spaced from the cup bottom; and
(b) the microwaveable shield layer extends along the cup surrounding wall and adjacent to the cup bottom.

10. A cup arrangement according to claim 1 wherein:
(a) the microwaveable shield layer extends along the cup surrounding wall spaced from the cup bottom; and
(b) the microwaveable susceptor layer extends along the cup surrounding wall and adjacent to the cup bottom.

11. A cup arrangement according to claim 1 wherein:
(a) the microwaveable susceptor layer extends along the cup surrounding wall between 20-80% of the overall length of the surrounding wall.

12. A cup arrangement according to claim 1 wherein:
(a) the microwaveable shield layer extends along the cup surrounding wall between 20-80% of the overall length of the surrounding wall.

13. A cup arrangement according to claim 1 wherein:
(a) the microwaveable shield layer extends along the cup surrounding wall from adjacent the cup bottom to 20-80% of the overall length of the cup surrounding wall and has a shield layer end remote from the cup bottom; and
(b) the microwaveable susceptor layer extends along the cup surrounding wall from adjacent the shield layer end in a direction toward the open top and extends over a length of between 20-80% of the overall length of the cup surrounding wall.

14. A cup arrangement according to claim 1 further including:
(a) a food item within the interior volume of the cup; and
(b) a food item within the storage area of the removable lid.

15. A cup arrangement according to claim 14 wherein the food item within the interior volume of the cup includes at least first and second food items;
(a) the first food item being in the interior volume of the cup and radially adjacent to the microwaveable shield layer; and
(b) the second food item being in the interior volume of the cup and radially adjacent to the microwaveable susceptor layer.

16. A cup arrangement according to claim 15 wherein:
(a) the first food item comprises ice cream, ice milk, custard, pudding, sorbet, malt, yogurt, fruit, fillings, cold confections, or blends thereof;
(b) the second food item comprises a brownie, cake, cookie, biscuit, bread, pie, or blends thereof; and
(c) the food item within the storage area comprises toppings including chocolate, caramel, butterscotch, fruit, syrup, fudge, cheese, frosting, or blends thereof.

17. A microwaveable cup arrangement comprising:
(a) a cup including a cup surrounding wall, a bottom, and an open top; the surrounding wall and the bottom together defining an interior volume;
(b) a removable lid removably secured to the cup at the open top; the removable lid having a closed top wall, and a perimeter sidewall surrounding the top wall;
(i) the perimeter sidewall defining a lid opening opposite of the top wall; and
(c) a susceptor plate oriented in the lid opening and axially spaced from the closed top wall;
(i) the susceptor plate defining an aperture arrangement in communication with the interior volume of the cup;
(ii) the susceptor plate, perimeter sidewall, and closed top wall together defining a lid storage volume.

18. A cup arrangement according to claim 17 wherein the perimeter sidewall defines a groove; the susceptor plate being oriented within the groove.

19. A cup arrangement according to claim 17 wherein:
(a) the perimeter sidewall includes an end rim arrangement; the end rim arrangement being constructed and arranged for frictional engagement with the cup surrounding wall at the open top; and
(b) the susceptor plate is axially spaced between the end rim arrangement and the closed top wall.

20. A cup arrangement according to claim 17 wherein the aperture arrangement in the susceptor plate comprises a plurality of through holes extending through the susceptor plate.

21. A cup arrangement according to claim 20 wherein the susceptor plate is from 1-10% open area.

22. A cup arrangement according to claim 17 further comprising:
(a) a food item oriented on the susceptor plate in the lid storage volume.

23. A cup arrangement according to claim 22 wherein the food item comprises toppings including chocolate, caramel, butterscotch, fruit, syrup, fudge, cheese, frosting, or blends thereof.

24. A cup arrangement according to claim 23 further comprising at least a second food item in the cup.

25. A cup arrangement according to claim 17 wherein the cup includes a microwaveable shield layer along at least a first portion of the cup.

26. A cup arrangement according to claim 25 wherein the cup includes a microwaveable susceptor layer along at least a second portion of the cup.

27. A cup arrangement according to claim 17 wherein the cup includes a microwaveable susceptor layer along at least a portion of the cup.

28. A cup arrangement according to claim 26 wherein:
(a) the cup includes a first food item comprising ice cream, ice milk, custard, pudding, sorbet, malt, yogurt, fruit, fillings, cold confections, or blends thereof;
(b) the cup includes a second food item comprising a brownie, cake, cookie, biscuit, bread, pie, or blends thereof; and
(c) the lid storage volume includes toppings including chocolate, caramel, butterscotch, fruit, syrup, fudge, cheese, frosting, or blends thereof.

29. A microwaveable food and packaging arrangement comprising:
(a) a cup including a cup surrounding wall, a bottom, and an open top; the surrounding wall and the bottom together defining an interior volume;
(b) a microwaveable shield layer along at least a first portion of the cup;
(c) a first food item in the cup interior volume and radially adjacent to the microwaveable shield layer;
(d) a microwaveable susceptor layer along at least a second portion of the cup;
(e) a second food item in the cup interior volume and radially adjacent to the microwaveable susceptor layer; and
(f) a removable lid removably secured to the cup at the open top;
(i) the removable lid defining a storage area; the storage area having an aperture arrangement in communication with the interior volume of the cup.

30. An arrangement according to claim 29 further comprising a third food item in the storage area of the lid.

31. An arrangement according to claim 30 further comprising a removable cover removably covering or exposing the storage area of the lid.

32. An arrangement according to claim 31 wherein:
(a) the first food item comprises ice cream, ice milk, custard, pudding, sorbet, malt, yogurt, fruit, fillings, cold confections, or blends thereof;
(b) the second food item comprises a brownie, cake, cookie, biscuit, bread, pie, or blends thereof; and
(c) the third food item comprises toppings including chocolate, caramel, butterscotch, fruit, syrup, fudge, cheese, frosting, or blends thereof.

33. An arrangement according to claim 29 wherein:
(a) the first food item comprises ice cream, ice milk, custard, pudding, sorbet, malt, yogurt, fruit, fillings, cold confections, or blends thereof; and
(b) the second food item comprises a brownie, cake, cookie, biscuit, bread, pie, or blends thereof.

34. An arrangement according to claim 29 wherein the first and second food items are frozen.

35. An arrangement according to claim 29 wherein:
(a) the microwaveable susceptor layer extends along the cup surrounding wall spaced from the cup bottom;
(b) the microwaveable shield layer extends along the cup surrounding wall and adjacent to the cup bottom;
(c) the lid includes a storage area wall and a floor connected to the storage area wall;
(i) the storage area wall and floor together defining the storage area;
(ii) the floor defining the aperture arrangement;
(iii) an outer wall radially spaced from and circumscribing the storage a wall; and
(iv) an outer rim radially and axially spaced from and circumscribing the outer wall; the outer rim being constructed and arranged for engaging the cup at the open top.

36. A method for making an edible arrangement; the method comprising:
(a) applying microwave energy to a cup arrangement; the cup arrangement holding at least first and second food items; the first and second food items being held in axial relation to each other within an interior volume of a cup;
(b) shielding at least the first food item from the microwave energy;
(c) heating at least the second food item with the microwave energy and a microwaveable susceptor;
(d) heating a third food item with the microwave energy held within a storage area of a removable lid removably attached to the cup; and
(e) allow the third food item to flow into the interior volume of the cup through an aperture arrangement in the storage area of the lid.

37. A method according to claim 36 further comprising removing a cover from the lid to expose the storage area.

38. A method according to claim 36 wherein the step of heating a third food item includes heating the third food item with a susceptor plate oriented within the removable lid.

39. A method according to claim 36 wherein the step of heating a third food item includes heating the third food item, which had been pre-stored in the storage area of the lid.

40. A method according to claim 36 wherein:
(a) the first food item comprises ice cream, ice milk, custard, pudding, sorbet, malt, yogurt, fruit, fillings, cold confections, or blends thereof;
(b) the second food item comprises a brownie, cake, cookie, biscuit, bread, pie, or blends thereof; and
(c) the third food item comprises toppings including chocolate, caramel, butterscotch, fruit, syrup, fudge, or blends thereof.
